(19) United States
(12) Patent Application Publication
(10) Pub. No.: US 2022/0128467 A1
(43) Pub. Date: Apr. 28, 2022

(54) Detecting and Monitoring Gas Leaks in an Industrial Setting

(71) Applicant: Saudi Arabian Oil Company, Dhahran (SA)

(72) Inventors: Adel Mofareh Al-Rashidi, Abqaiq (SA); Omar Al-Mohisin, Khobar (SA); Mohammed Al-Saeed, Khobar (SA)

(21) Appl. No.: 17/082,989

(22) Filed: Oct. 28, 2020

(51) Int. Cl. G01N 21/61; H04N 5/33

(52) U.S. Cl. CPC G01N 21/61; H04N 5/33

(57) ABSTRACT

Systems and methods for monitoring an industrial site including: a distributed control system and a closed-circuit television (CCTV) system. The distributed control system includes a plurality of safety sensors distributed across the industrial site, each safety sensor associated with a specific area of the industrial site and each safety sensor operable to transmit an alert signal in response to detection of a target gas. The CCTV system in electronic communication with the integration node and including a server and a plurality of cameras. The server is operable to direct at least one of the plurality of cameras at the specific area of the industrial site associated one of the safety sensors that generated an alert signal received by the closed-circuit television system.

### TECHNICAL FIELD

The present disclosure generally relates to a gas detection and monitoring system, particularly a camera-based gas and monitoring detection system.

### BACKGROUND

Gas sensors can be used to detect a gas leak or other emissions and can interface with a control system so a process can be automatically shut down. Gas sensors can sound an alarm to operators in the area where the leak is occurring, giving them the opportunity to leave. Gas sensors are used widely in industry to detect combustible, flammable and toxic gases, and oxygen depletion.

Cameras such as optical gas imaging cameras can be used to visualize gas and monitor installations in remote or hazardous areas for gas leaks. Continuous monitoring can catch dangerous, costly hydrocarbon or volatile organic compound leaks quickly. Such cameras can be used in industrial settings, such as natural gas processing plants and offshore platforms.

### SUMMARY

This specification describes technology that automatically controls plant surveillance cameras based on input from a distributed control system (DCS) based on sensors (e.g., gas sensors, smoke sensors, fire sensors, and wind sensors. Sensors of the DCS in different plant areas are connected to a camera system (e.g., a closed circuit television (CCTV) system), typically via an input/output (I/O) module. In case of a gas leak or other hazardous condition detected by the sensors, a signal sent by the DCS identifying the affected area triggers the camera system to direct individual cameras of the system at the identified area of the industrial. For example, a prototype gas detection system was developed with a hydrogen sulfide (H₂S)—lower explosive limit (LEL) gas detection system and a CCTV. The complex where the prototype was tested contains more than 400 gas sensors distributed around multiple plants and a CCTV system that includes 21 cameras scattered around the multiple plants. Implementing the technology described in this specification enables provides a CCTV system which automatically orients cameras in response to detected gas leaks in the field and captures the whole visual sequence of events of any incident. This video record will be very valuable for investigation and analysis of incidents on the site. The CCTV system can also be used to provide remote safety guidance for onsite rescue teams.

In one approach, an I/O module receives activation signals from the plant DCS. The DCS is a computerized control system for a process or plant in which autonomous controllers are distributed throughout the system, but there is no central operator supervisory control. In contrast to systems that use centralized controllers (e.g., discrete controllers located at a central control room or within a central computer), the DCS approach can increase reliability and reduce installation costs by localizing control functions near the process plant, with remote monitoring and supervision.

The I/O module then sends a signal to a CCTV network switch which is connected to the camera system. The system is preconfigured to direct cameras at adjacent linked gas sensors and, in particular, to the activated sensor. Each camera can be preconfigured to several preset views so that it covers all adjacent gas sensors.

In one aspect, gas detection systems for monitoring an industrial site include: a distributed control system comprising a plurality of gas sensors distributed across the industrial site, each gas sensor associated with a specific area of the industrial site and each gas sensor operable to transmit an alert signal in response to detection of a target gas; a integration node in electronic communication with the plurality of gas sensors of the distributed control system, the integration node operable to forward the alert signal; and a closed circuit television (CCTV) system in electronic communication with the integration node, the CCTV system comprising a server and a plurality of cameras, the server operable to direct at least one of the plurality of cameras at the specific area of the industrial site associated one of the gas sensors that generated an alert signal received by the closed circuit television system.

In one aspect, methods for assessing hazardous conditions at an industrial site include: sending an alert signal from a gas sensor upon detection of a target gas; directing at least one camera of a CCTV system on an area of the industrial site associated with the gas sensor sending the alert signal; and activating an alarm in response to the alert signal from the gas sensor.

In one aspect, detection and monitoring systems for monitoring an industrial site include: a distributed control system comprising a plurality of safety sensors distributed across an industrial site, each safety sensor associated with a specific area of the industrial site and each safety sensor operable to transmit an alert signal in response to detection of a target gas; a closed-circuit television (CCTV) system in electronic communication with the integration node, the CCTV system comprising a server and a plurality of cameras, the server operable to direct at least one of the plurality of cameras at the specific area of the industrial site associated one of the safety sensors that generated an alert signal received by the closed-circuit television system.

Embodiments of these aspects can include one or more of the following features.

In some embodiments, systems and methods the CCTV system also includes comprises monitors operable to display video signals received from cameras. In some cases, the monitors are located in an emergency control center.

In some embodiments, the gas sensors are configured to generate alert signals comprising a concentration of the gas detected. In some cases, systems and methods also include control logic operable to prioritize camera assignments based on alert signals received from multiple gas sensors.

In some embodiments, the CCTV system includes a transmitter activated by receipt of an alert signal. In some cases, the transmitter is operable to provide an alarm by at least one of audible alarms, email, or telephone.

The technology described in this specification is more broadly effective than systems that use hyperspectral cameras and artificial intelligence (AI) visual analysis that automatically monitors and grades gas leak, and fire incidents thus eliminating the need for manual camera control by operators. In particular, this technology is effective at detecting heavy gases such as hydrogen sulfide (H₂S) at early stages of leak even if they are at low level and behind process obstacles (e.g., piping, process vessels, etc.) that can interfere with video-based detection. In addition, the technology described in this specification is less expensive than systems that use hyperspectral cameras and AI visual analysis because this technology does not require dedicated costly material for each location such as special type of cameras with its accessories such as IR and advance costly analysis processor.

The technology described in this specification does not need significant additional infrastructure or hardware to implement. It can use plants' standard infrastructure with minimal needs for hardware and integration which makes it easy to implement. The primary upgrade is I/O modules to integrate existing DCS sensors with exiting camera system infrastructure. Only limited maintenance is required after the first installation and configuration without any additional support for the system. Once installed, the technology is anticipated speed up emergency responses and reducing the losses by detecting and providing video of the location of a potential incident.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic system overview.

FIG. 2 is an outline of the connections and communications between system components.

FIG. 3A-5 are illustrations of a prototype of the system of FIG. 1.

FIG. 6 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

This specification describes technology that automatically controls plant surveillance cameras based on input from a DCS based on sensors (e.g., gas sensors, smoke sensors, fire sensors, and wind sensors. Sensors of the DCS in different plant areas are connected to a camera system (e.g., a CCTV system), typically via an I/O module. In case of a gas leak or other hazardous condition detected by the sensors, a signal sent by the DCS identifying the affected area triggers the camera system to direct individual cameras of the system at the identified area of the industrial.

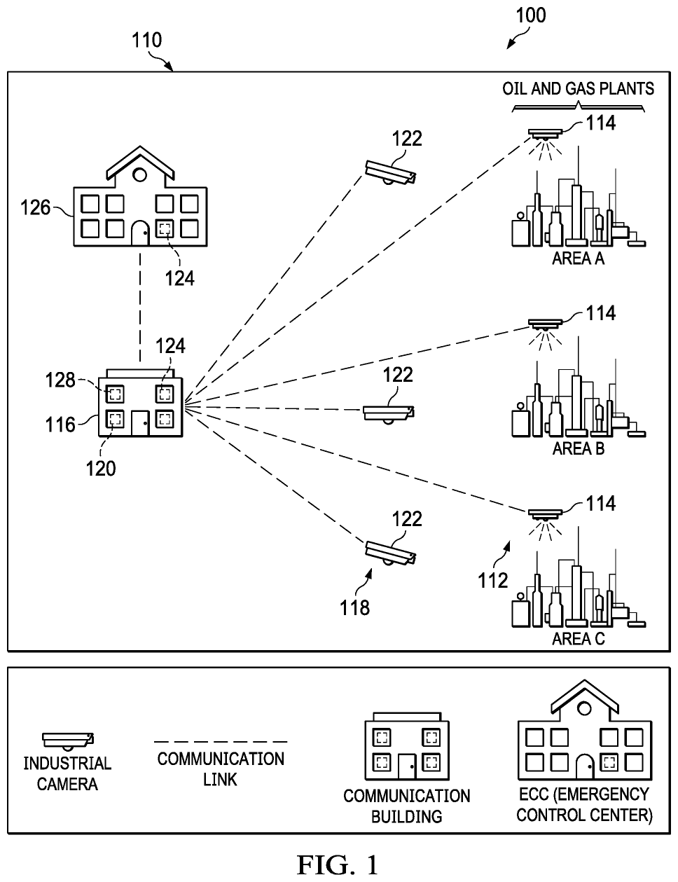

FIG. 1 provides a schematic overview illustrating one approach to implementing this technology. Although the technology is described with reference a gas detection system monitoring an industrial site, similar approaches can be used for other applications (e.g., controlling cameras in home and urban settings). In the illustrated example, a gas detection system 100 is configured for monitoring an industrial site 110 including multiple oil and gas plants. The system 100 includes a distributed control system 112 which includes sensors (in this example, gas sensors 114) distributed across the industrial site 110, a integration node 116 in electronic communication with the distributed control system 112, and a CCTV system 118 in electronic communication with the integration node 116.

Each gas sensor 114 is associated with a specific area of the industrial site 110 and is operable to transmit an alert signal in response to detection of a target gas. For example, the prototype system included H₂S and LEL sensors. The gas sensors 114 are configured to generate alert signals indicating the presence of a target gas. In some systems, the alert signal can include additional information such as a concentration of the gas detected.

Although the integration node 116 is illustrated as being an I/O module in a communication building, the integration node can be an appropriate I/O module in other locations (e.g., an emergency control center or other local or remote control centers). In use, the integration node 116 is operable to forward the alert signal(s) generated by one or more of the sensors 114 of the DCS 112 to the CCTV system 118.

The CCTV system 118 includes a server 120 and a plurality of cameras 122. The server 120 is operable to direct one or more of the cameras 122 at the specific area of the industrial site associated one of the gas sensors 114 that generated an alert signal received by the CCTV system 118. The CCTV system 118 can be used to observe parts of the site 110 from remote locations such as a central control room or the emergency control center (e.g., when the environment is not suitable for humans). For example, the emergency control center (ECC) is typically a control center equipped to serve as an alternate remote-control room for the plant to be used in incident response by trained emergency responders. In this approach, the ECC is also equipped with plant CCTV automated to focus on hazardous events to help enable a quick reaction during incidents. The CCTV system 112 can operate continuously or only as required to monitor a particular event. Some CCTV systems 112 incorporate digital video recorders to provide long-term recording. In some cases, the cameras 122 support recording directly to network-attached storage devices or internal flash memory.

The CCTV system 118 also optionally includes monitors 124 operable to display video signals received from cameras 122. For example, the CCTV system can include monitors 124 at the communication building or an emergency control center 126 for the industrial site 110.

The system 100 can also include a transmitter 128 activated by receipt of an alert signal. The transmitter 128 is typically operable to provide an alarm, for example, by at least one of audible alarms (e.g., on-site sirens), visual alarms (e.g., on-site flashing lights), email (e.g., to plant management and/or emergency personnel), or telephone (e.g., to plant management and/or emergency personnel). In the illustrated system, the transmitter 128 is shown as being located in the communication building but the transmitter 128 can be placed at other locations that are unlikely to impacted by incidents at the site. In addition, some systems include multiple transmitters at different locations

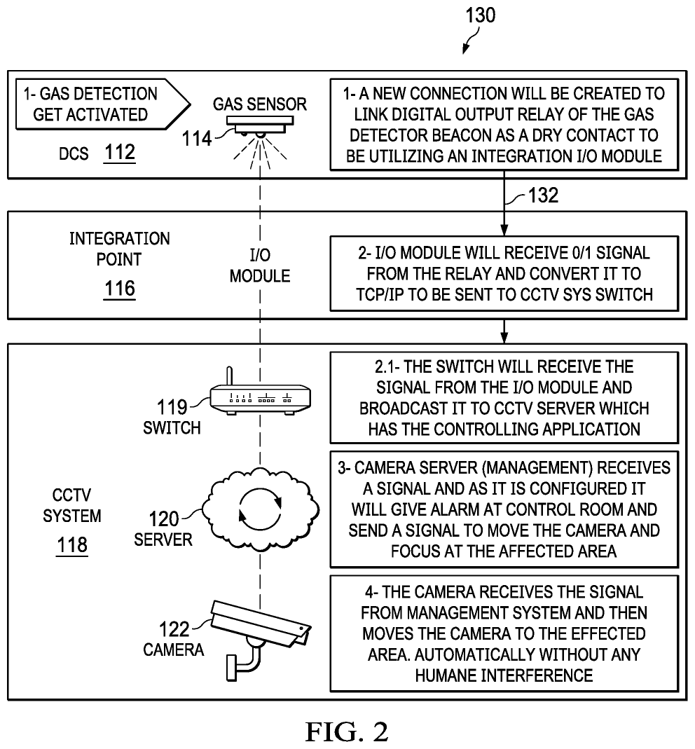

FIG. 2 is an outline of the connections and communications between system components including the DCS 112, the integration node 116, and the CCTV system 118 when an alert signal is generated by a sensor. As before, the communications and method 130 are discussed with respect to the example of a DCS 112 with gas sensors 114 and a CCTV system but could be implemented with other sensors and camera systems.

The method 130 is activated when one or more of the gas sensors 114 of the DCS 112 detect a target gas. When activated, the DCS 112 creates a new connection to link a digital output relay of the gas sensor 114 as a dry contact (i.e., not connected to an energized circuit) to connect to the integration I/O module 116. The alert signal 132 from the DCS 112 indicates the presence of a target gas. In some systems, the alert signal can include additional information such as a concentration of the gas detected.

The integration node 116 is operable to forward the alert signal(s) generated by one or more of the gas sensors 114 of the DCS 112 to the CCTV system 118. In the prototype, the integration node 116 receives the alert signal(s) 132 from the DCS 112 and converts the alert signal(s) to TCP/IP format before forwarding the alert signal(s) to a switch 119 of the CCTV system 118.

The switch 119 of the CCTV system 118 receives the alert signal(s) and transfers them to the server 120. The application or control logic module 134 controlling the CCTV system 118 resides on the server 120. In addition to standard functions, the control logic module 119 is operable to direct one or more of the cameras 122 at the specific area of the industrial site associated one of the gas sensors 114 that generated an alert signal received by the CCTV system 118.

The control logic module 119 of the server 120 is operable to prioritize camera assignments based on alert signals 134 generated by multiple gas sensors 114. The prioritization approach can be based on zones (distance) and the concentration of detected target gas(es). In the prototype, each camera had a matrix that assigned each sensor to a zone based on the visibility of the area associated the sensor from the individual camera with Zone 1 indicating the area is visible from the camera (e.g., a clear line of sight), Zone 2 indicating the area is partially visible from the camera (e.g., some coverage but line of sight obstructed by plant equipment or distance), and Zone 3 indicating that the area is not visible from the camera.

This approach can be illustrated by a simple example with two cameras and five sensors. The areas associated with Sensors 1, 2, and 4 are clearly visible from Camera 1, the area associated with Sensor 3 is partially visible from Camera 1, and the area associated with Sensors 5 is not visible from Camera 1. The areas associated with Sensors 3 and 4 are partially visible from Camera 2 and the areas associated with Sensors 1, 2, and 5 are not visible from Camera 2. The acceptable level of hydrogen sulfide is 20 parts per million (ppm).

An event occurs and the cameras receive alert signals with Sensor 1 reporting 30 ppm, Sensor 2 reporting 25 ppm, Sensor 3 reporting 50 ppm, Sensor 4 reporting 10 ppm, and Sensor 5 reporting 55 ppm. The decision matrix for these cameras can be illustrated by the following tables with concentration of hydrogen sulfide detected by each sensor noted in the zone that the sensor is associated with.

Camera 1

| | Sensor 1 | Sensor 2 | Sensor 3 | Sensor 4 | Sensor 5 |
|---|---|---|---|---|---|
| Zone 1 (visible) | 30 ppm | 25 ppm | | 10 ppm | |
| Zone 2 (partially visible) | | | 50 ppm | | |
| Zone 3 (not visible) | | | | | 55 ppm |

Camera 2

| | Sensor 1 | Sensor 2 | Sensor 3 | Sensor 4 | Sensor 5 |
|---|---|---|---|---|---|
| Zone 1 (visible) | | | | | |
| Zone 2 (partially visible) | | | 50 ppm | 10 ppm | |
| Zone 3 (not visible) | 30 ppm | 25 ppm | | | 55 ppm |

In this example, Camera 1 is receiving alert signals from three Zone 1 sensors (i.e., Sensor 1, Sensor 2, and Sensor 4). Camera 1 will rotate to the area associated with Sensor 1 since its alert signal has the highest reported concentration of the three Zone 1 sensors. Although the Sensor 3 and Sensor 5 alert signals have higher reported concentrations, the areas associated with these sensors are not as visible from Camera 1.

In contrast, Camera 2 is not receiving alert signals from any Zone 1 sensors. Camera 2 is receiving alert signals from two Zone 2 sensors (i.e., Sensor 3 and Sensor 4). Camera 2 will rotate to the area associated with Sensor 3 since its alert signal has the highest reported concentration of the two Zone 2 sensors. Although the Sensor 5 alert signal has higher reported concentrations, the area associated with this sensor is not as visible from Camera 2.

Although this example has prioritization is based on zone then target gas concentration, some systems have prioritization based on other approaches. For example, some have prioritization based on directing cameras to the areas with the highest target gas concentration that are at least partially visible (i.e., in effect grouping Zones 1 and 2 together). Some systems incorporate other factors such as the likelihood personnel are present in a specific area. In some implementations, the system is enhanced by adding other sensor such as wind directions sensors interfaced to CCTV application screen and used by an incident commander to direct the people in the affected area (who can't see wind direction sock) to safest assembly area.

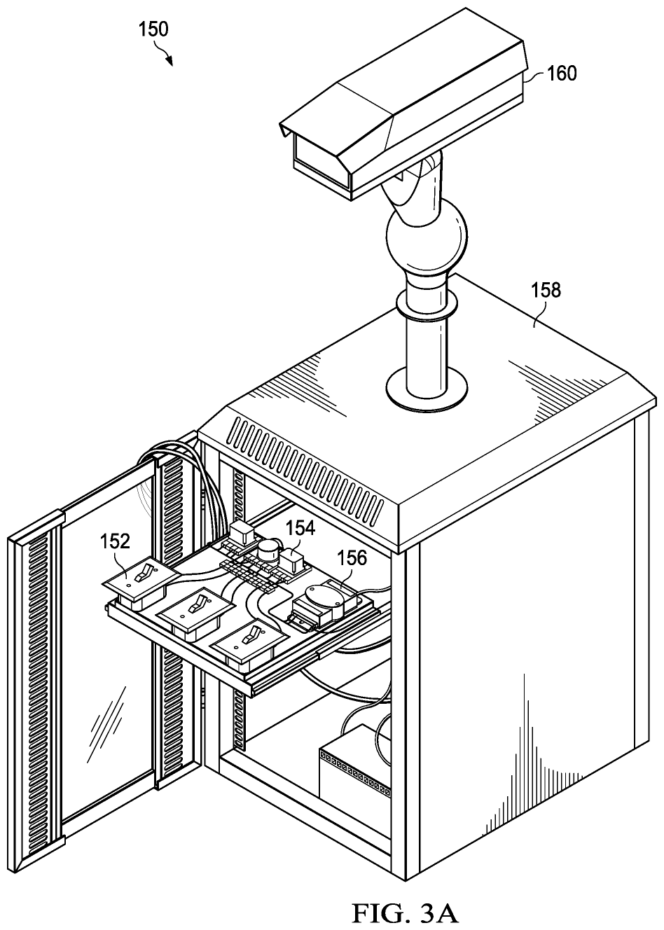

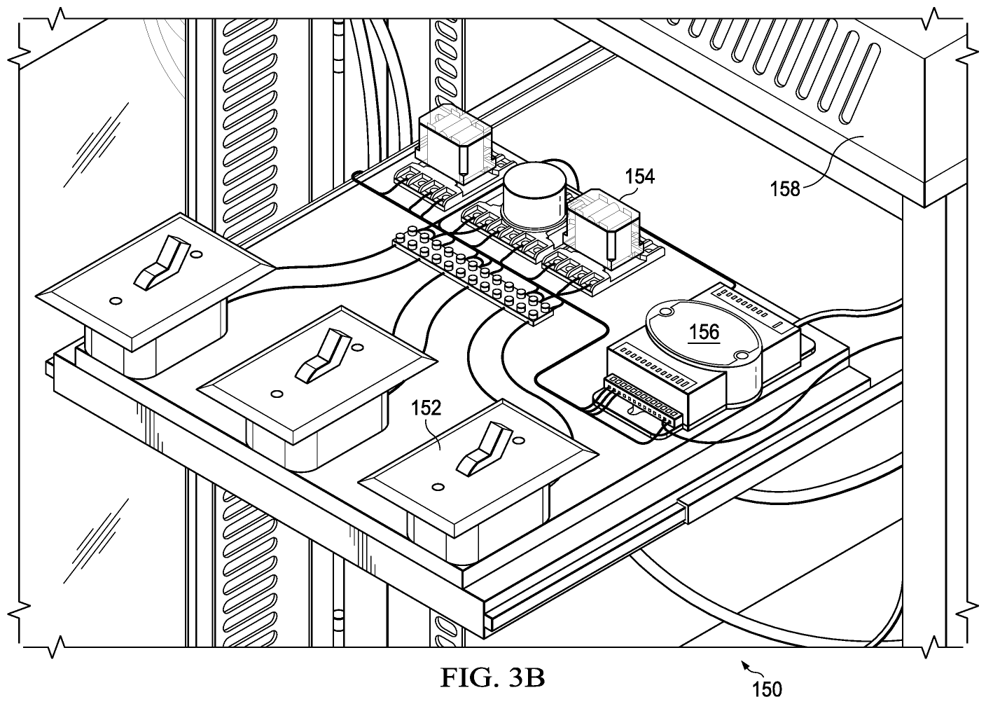

FIG. 3A-5 are illustrations of an early prototype of a used to test the underlying technology of a hydrogen sulfide (H₂S)—lower explosive limit (LEL) gas detection system and a CCTV at an industrial complex with more than 400 gas sensors distributed around multiple plants and a CCTV system that includes 21 cameras scattered around the multiple plants.

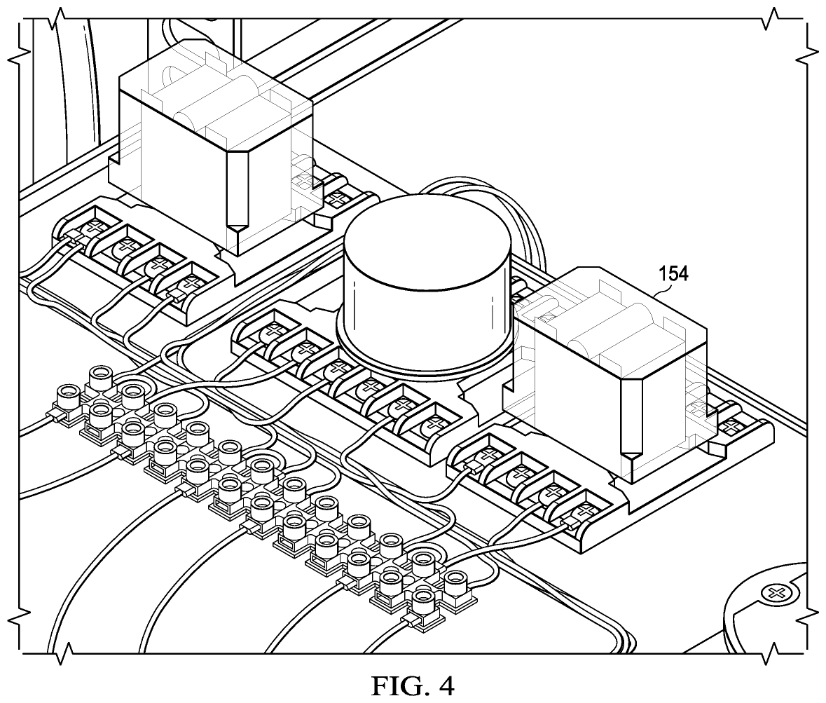

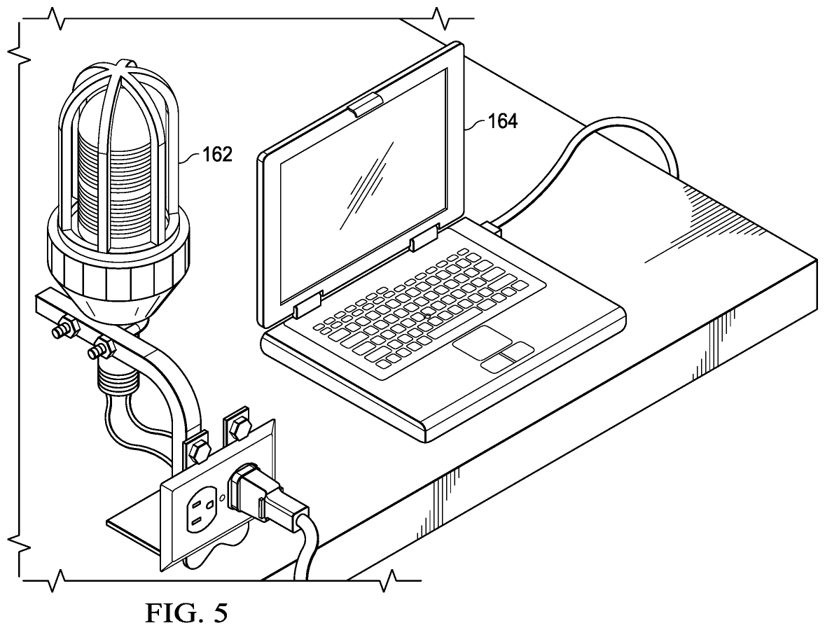

FIGS. 3A and 3B shows an initial prototype 150 before DCS components were added. Light switches 152 (and associated lights 162 shown in FIG. 5) were used to simulate gas detectors with manual operation of the light switches 152 simulating detection of a target gas by sensors. Relays 154 attached to the light switches 152 were used to simulate the DCS functionality. An I/O module 156 connected a CCTV 158 with a single camera 160. FIG. 4 is a more detailed view of the relays 154.

FIG. 5 shows a light 162 connected to one of the light switches 152 9sse FIGS. 3A and 3B) and used to simulate a gas sensor. A laptop computer 164 was used to display output from the camera 160 (see FIGS. 3A and 3B) and verify that camera orientation responded as expected to the simulated gas leaks by reorienting to the area associated with each switch.

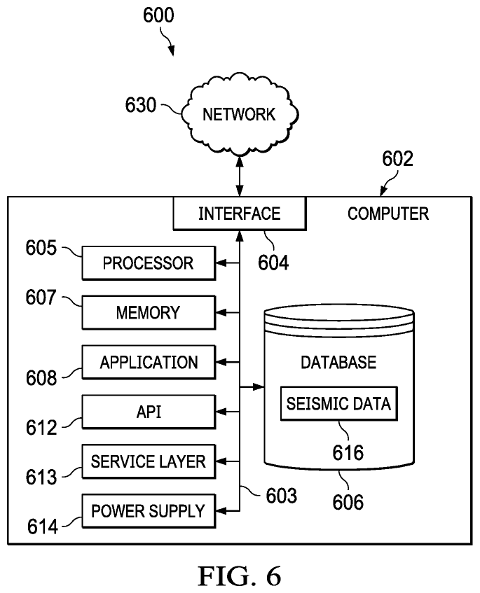

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user- or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

What is claimed is:

1. A gas detection system for monitoring an industrial site, the system comprising:
a distributed control system comprising a plurality of gas sensors distributed across the industrial site, each gas sensor associated with a specific area of the industrial site and each gas sensor operable to transmit an alert signal in response to detection of a target gas;
a integration node in electronic communication with the plurality of gas sensors of the distributed control system, the integration node operable to forward the alert signal; and
a closed circuit television (CCTV) system in electronic communication with the integration node, the CCTV system comprising a server and a plurality of cameras, the server operable to direct at least one of the plurality of cameras at the specific area of the industrial site associated one of the gas sensors that generated an alert signal received by the closed circuit television system.

2. The system of claim 1, wherein CCTV system further comprises monitors operable to display video signals received from cameras.

3. The system of claim 2, wherein the monitors are located in an emergency control center.

4. The system of claim 1, wherein the gas sensors are configured to generate alert signals comprising a concentration of the gas detected.

5. The system of claim 4, system further comprises control logic operable to prioritize camera assignments based on alert signals received from multiple gas sensors.

6. The system of claim 1, wherein the CCTV system comprises a transmitter activated by receipt of an alert signal.

7. The system of claim 6, wherein the transmitter is operable to provide an alarm by at least one of audible alarms, email, or telephone.

8. A method for assessing hazardous conditions at an industrial site, the method comprising:
sending an alert signal from a distributed control system comprising a plurality of gas sensors upon detection of a target gas to a server;
directing, by the server, at least one camera of a CCTV system on an area of the industrial site associated with the gas sensor sending the alert signal; and
activating an alarm in response to the alert signal from the gas sensor.

9. The method of claim 8, wherein CCTV system further comprises monitors operable to display video signals received from cameras.

10. The method of claim 9, wherein the monitors are located in an emergency control center.

11. The method of claim 8, wherein the gas sensors are configured to generate alert signals comprising a concentration of the gas detected.

12. The method of claim 11, system further comprises control logic operable to prioritize camera assignments based on alert signals received from multiple gas sensors.

13. The method of claim 8, wherein the CCTV system comprises a transmitter activated by receipt of an alert signal.

14. A detection and monitoring system for monitoring an industrial site, the system comprising:
a distributed control system comprising a plurality of safety sensors distributed across an industrial site, each safety sensor associated with a specific area of the industrial site and each safety sensor operable to transmit an alert signal in response to detection of a target gas;
a closed-circuit television (CCTV) system in electronic communication with the integration node, the CCTV system comprising a server and a plurality of cameras, the server operable to direct at least one of the plurality of cameras at the specific area of the industrial site associated one of the safety sensors that generated an alert signal received by the closed-circuit television system.

15. The system of claim 14, wherein CCTV system further comprises monitors operable to display video signals received from cameras.

16. The system of claim 15, wherein the monitors are located in an emergency control center.

17. The system of claim 14, wherein the safety sensors are configured to generate alert signals comprising a concentration of the gas detected.

18. The system of claim 17, system further comprises control logic operable to prioritize camera assignments based on alert signals received from multiple safety sensors.

19. The system of claim 14, wherein the CCTV system comprises a transmitter activated by receipt of an alert signal.

20. The system of claim 14, wherein the plurality of safety sensors comprises a plurality of gas sensors.
